(19) United States
(12) Patent Application Publication
(10) Pub. No.: US 2010/0313019 A1
(43) Pub. Date: Dec. 9, 2010

(54) METHOD AND SYSTEM FOR MANAGING A SOFTWARE APPLICATION ON A MOBILE COMPUTING DEVICE

(76) Inventor: Francois Malan Joubert, Stellenbosch (ZA)

Correspondence Address: Adams and Reese LLP, 1221 McKinney Street, Suite 4400, Houston, TX, 77010, US

(21) Appl. No.: 12/745,875

(22) PCT Filed: Dec. 10, 2008
(86) PCT No.: PCT/IB08/55189

§ 371 Date: Aug. 24, 2010

(30) Foreign Application Priority Data
Dec. 10, 2007 (ZA) 2007/10719

(51) Int. Cl. H04L 9/32; G06F 21/00

(52) U.S. Cl. 713/168; 726/9

(57) ABSTRACT

A method of and system for managing a one time password security software application employed on a mobile computing device (12) are provided. The method comprises generating a command message comprising command data specifying a type of command to be performed on the one time password security application employed on the mobile computing device, and a unique identification code to identify a data record on which the command is to be performed or to identify a one time password algorithm and its associated authentication entity on which the command is to be performed. This message is transmitted by a turn key server (18) to the mobile computing device (12) for execution on the mobile computing device thereby to manage the one time password security software application.

### BACKGROUND OF THE INVENTION

THIS invention relates to a method and system for managing a software application on a mobile computing device.

The use of one time passwords (OTPs) to enhance security in accessing a company network, for example, is well established. The most common way of implementing a system using OTPs is to provide a hardware token to each user, which the user must plug into a terminal such as a personal computer (PC) which is used to access the network. The token contains hardware and software and generates a unique password each time the user accesses the network. The cost and logistics involved in providing each user of such a network with a hardware token are substantial.

In order to obviate some of the disadvantages of the above-mentioned tokens, systems and methods have been developed to deploy a one-time password security application on a mobile computing device. This OTP application enables the mobile computing device to be used as an authentication token, equivalent to a dedicated authentication token as currently used in other systems to gain access to secure networks.

A need has been identified to remotely and securely manage these OTP applications that have been downloaded on the mobile computing devices.

It is accordingly an object of the invention to provide a method and system which can be used, amongst other things, for managing a one time password application deployed on a mobile computing device.

### SUMMARY OF THE INVENTION

According to the invention there is provided a method of managing a one time password security software application employed on a mobile computing device, the method comprising:
generating a command message comprising
   command data specifying a type of command to be performed on the one time password security application employed on the mobile computing device, and
   a unique identification code to identify a data record on which the command is to be performed or to identify a one time password algorithm and its associated authentication entity on which the command is to be performed; and
transmitting the command message to the mobile computing device for execution on the mobile computing device thereby to manage the one time password security software application.

The mobile computing device is preferably a mobile telephone, a Personal Digital Assistant (PDA) or another mobile computing device with wireless connectivity.

The type of command specified by the command message may, for example, be a command to update or add data associated with the authentication entity, a command to remove the authentication entity, a command to perform a synchronisation operation for the specified authentication entity, or commands to either add, update or delete general data records associated with the one time password security application.

Preferably, the method may further comprise encrypting the command message prior to transmission.

The encryption may be symmetric or asymmetric encryption.

The command message is typically transmitted from a turnkey server associated with the authentication entity identified through the unique identification code. Preferably a trust relationship exists between the mobile computing device and the authentication entity prior to the transmittal of the command message. The trust relationship between the mobile computing device and the authentication entity may have been established during the installation of the one time password security application on the mobile computing device.

Alternatively, in the event that a trust relationship does not exist between the authentication entity associated with the command message and the mobile computing device, the command message may be transmitted from a turnkey server associated with a trusted authentication entity that is not associated with the command message.

In these circumstances, the command message may first be transmitted from the turnkey server not being in a trust relationship with the mobile computing device, to the turnkey server being in a trust relationship with the mobile computing device.

Preferably, the command message may include a security key associated with the turnkey server not being in a trust relationship with the mobile computing device.

The step of encrypting the command message may include transmitting a security key to the user of the mobile computing device over a second communication channel, where the security key is preferably a PIN.

The step of encrypting the command message may further include encrypting the command message with an existing shared security key which was transmitted to the mobile commuting device during the installation process of the one time password security software application.

The method may further comprise, receiving, at the mobile computing device, the command message and executing the command message.

The step of executing the command message may further comprise decrypting the command message.

The method may further comprise registering an SMS port during an installation process of the one time password security software application, and transmitting the one time password security software application which includes a remote management module to the registered SMS port.

Preferably the method may further comprise receiving a port conflict message from the mobile computing device in response to transmitting the one time password security software application to the registered SMS port and retransmitting the one time password security software application to an alternative SMS port of the mobile computing device.

According to a further aspect of the invention, there is provided a system to manage a one time password security software application employed on a mobile computing device,

the system comprising:
a secure server of an authentication entity associated with a network, the network to be accessed by the mobile computing device through the use of a one time password; the system operable to:
generate a command message comprising
   command data specifying a type of command to be performed on the one time password security application employed on the mobile computing device, and
   a unique identification code to identify a data record on which the command is to be performed or to identify a one time password algorithm and its associated authentication entity on which the command is to be performed; and
transmit the command message to the mobile computing device for execution on the mobile computing device thereby to manage the one time password security software application.

The secure server may be configured to establish, during a registration process, a trust relationship with the authentication entity.

The secure server may further be configured to generate the command message by first receiving from a second server of a second authentication entity associated with a second network the command message.

### BRIEF DESCRIPTION OF THE DRAWINGS

FIG. 1 is a simplified schematic diagram of a system for managing a security software application on a mobile computing device of a user according to the present invention;

FIG. 2 is a flow chart illustrating major steps in the installation process of a one-time password security application on a mobile computing device, the one-time password security application including a remote management module;

FIGS. 3 to 6 show the structure of example embodiments of a command message, an unencrypted command message, a PIN-encrypted command message and a key encrypted command message;

FIG. 7 is a process flow illustrating command messages originating from a variety of sources and their execution; and

FIG. 8 is a process flow illustrating the execution of a command placed in a queue.

### DESCRIPTION OF AN EMBODIMENT

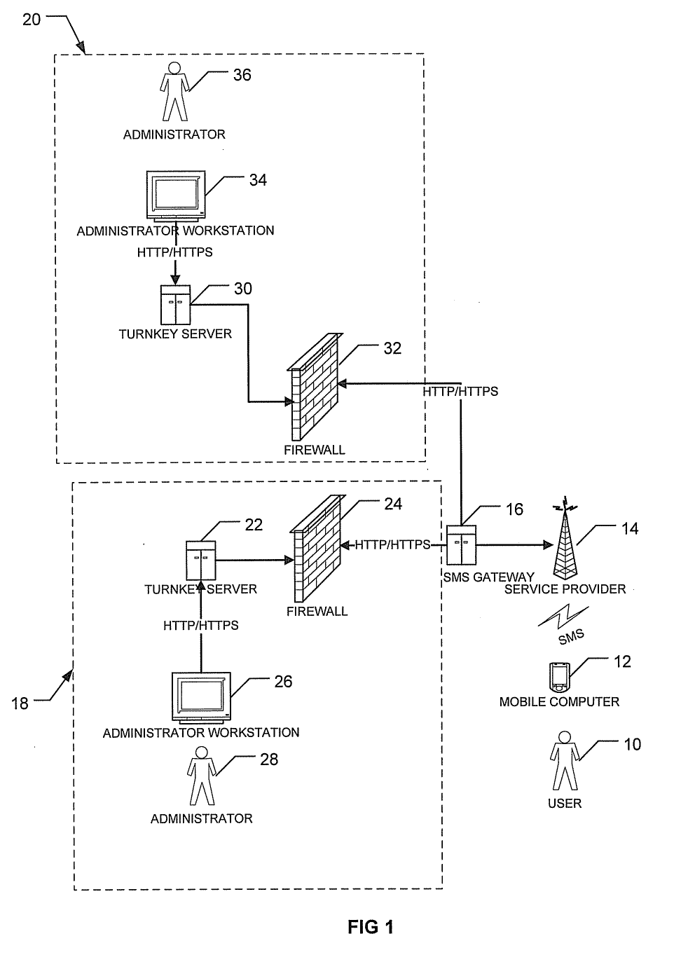

FIG. 1 shows, in a highly simplified schematic format, a system for managing a software application on a mobile computing device of a user.

For purposes of this application, the term “mobile computing device” includes, but is not limited to, mobile telephones (including cellular telephones), Personal Digital Assistants (PDAs), Smartphones, laptop or notebook computers, and other such devices. In general, devices of this kind have a user interface including a display and a keypad or keyboard, an onboard processor and software, and a communication interface which is preferably wireless.

The present invention is concerned with the remote and dynamic management of a software application on such a mobile computing device. One example of such an application is a one-time password (OTP) security application, and the following description is based on this example.

In FIG. 1, a user 10 has a mobile computing device 12, shown as a PDA. The device 12 is able to communicate via various communication channels, for example, a push SMS (short messaging system) message, with a wireless telephone network 14 which includes an SMS gateway 16.

In this example embodiment, it is shown that the user 10 may wish to gain access to two separate networks 18 and 20, which networks each respectively act as authentication entities. The first network 18 to which the user wishes to gain access comprises a turnkey server 22, a firewall 24 and an administrator workstation 26 (other components of the network are omitted for clarity) which workstation is operated by an administrator 28. Similarly, the second network 20 to which the user may wish to gain access comprises a turnkey server 30, a firewall 32 and an administrator workstation 34 (other components of the network are omitted for clarity) which workstation is operated by an administrator 36.

In the described embodiment of the invention, it is desired to manage a software application already deployed on the mobile computing device 12 of the user 10 to enable the administrators 28 and 36 of the networks 18 and 20 to add, remove, change data which enables the software installed on the mobile computing device 10 to operate as an authentication token. For example, in various embodiments of the invention the system and method allow operations such as token synchronisations, algorithm changes and the addition of new authentication entities in a secure environment, without user interaction.

As mentioned, the software application that has been installed and deployed on the mobile computing device 12 is a one-time password (OTP) security application, which may have been deployed on the mobile computing device 12 using a method and system as described in International Patent Application No. PCT/IB2008/051580, published as WO 2008/132670. This document is herein incorporated by reference. The deployed OTP security application allows the user 10 to access the network 18 through the mobile computing device 12 acting as an authentication token.

However, it will be appreciated that the authentication token is merely the software application deployed on the mobile computing device 12. The token provides, in an example embodiment, a management module to allow for the implementation of this invention, as well as other plug-in-based technology that allows new (e.g., third-party) modules to be developed and integrated into the token without requiring significant changes to the token itself. These modules may be able to perform a variety of operations. In order to achieve this, remote and dynamic access of data associated with the authentication token (known as “general data records”) is necessary.

In the example embodiment shown in FIG. 1, network or authentication entity 18 has installed the OTP security application on the mobile computing device 12. During this installation process, user data had been captured by the administrator 28. Also, a trust relationship was established between the network or authentication entity 18 and the mobile computing device 12, by, for example, downloading security keys to the mobile computing device 12.

In accordance with the method and system of PCT/IB2008/051580, security during the installation process may have been achieved by using e-mail messages as the mechanism for distributing invitations to the user 10 to deploy the security software application and to set the user 10 up for secure access to the network, with a separate synchronised deployment process using another computing device of the user. During the installation process, the security key need not have been delivered to the user by e-mail, and in some embodiments of the system and method of PCT/IB2008/051580 the security may have been communicated verbally, in writing, or in some other way. The important thing is that a trust relationship already exists between the authentication entity 18 and the mobile computing device 12 (also called the authentication token).

It will be appreciated that, in the example embodiment, and particular as care would have been taken during the installation process of the security software, any transmissions to the mobile computing device 12 during the management of the OTP security application also have to be secure.

In the system illustrated in FIG. 1, the turnkey server 22 of network 18 is located behind a firewall 24, which protects the turnkey server 22 from Internet-based attacks.

In one example embodiment, the mobile computing device 12 acting as the authentication token use different OTP algorithms for the generation of one time passwords for each of the different authentication entities it supports. For example, the authentication token will use two distinct OTP algorithms to access the network 18 and the network 20 (once the network 20 has been added as an authentication entity to the authentication token).

An OTP algorithm and authentication entity therefore form a unique pair on the mobile computing device 12 and this pair is identified by a unique identification (ID) number, e.g., an authentication entity ID. Each such pair has a record of data associated with it by means of this authentication entity ID. The record, which is stored on the mobile computing device 12, contains the data used by an OTP algorithm to generate an OTP for the specific authentication entity. It is these data records (also called “authentication entity records”) that are managed by an administrator 28 employing the system and method of the present invention to allow for the remote management of the OTP security application.

By using “push SMS”-technology in the communication between the authentication entity 18 and the mobile computing device 12, the remote administration and management of the authentication token are possible even when the OTP security application is not active on the user's mobile computing device 12.

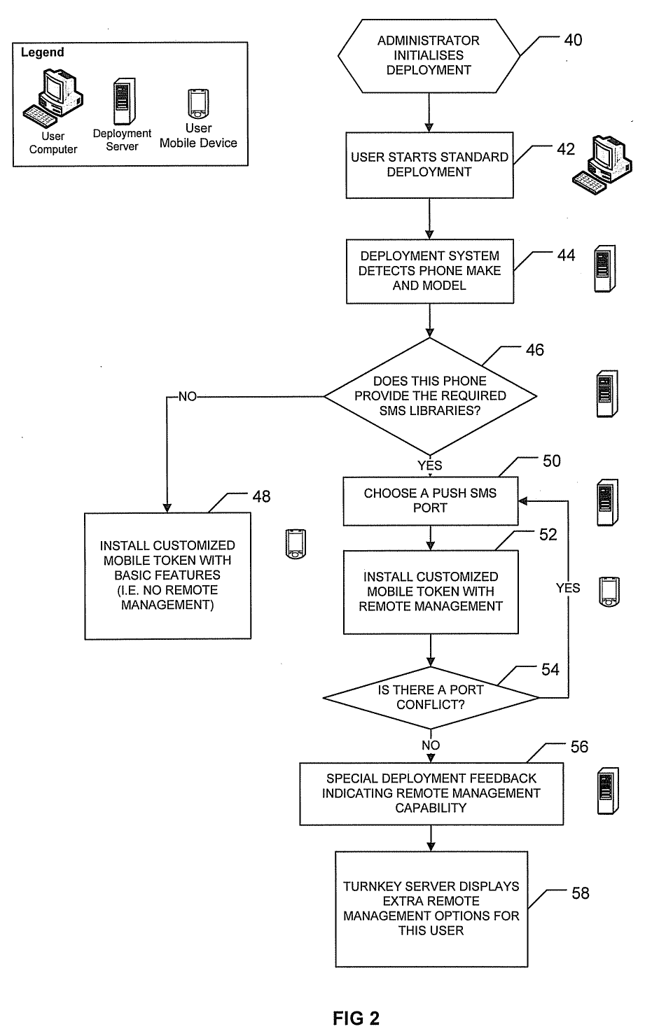

In accordance with the deployment system of the authentication token as described in PCT/IB2008/051580, a customized OTP application is delivered to the mobile computing device 12 of a user 10. This is shown by block 40 and 42 of the flow diagram of FIG. 2. The mobile computing device 12 typically provides feedback information on the installation outcome.

Not all mobile computing devices may provide the necessary SMS libraries (e.g., JSR 120: Wireless Messaging API or JSR 205: Wireless Messaging API 2.0) required for the remote management of the OTP security application. It may therefore be necessary for the deployment system of the OTP security application to determine the make and model of the user's mobile computing device 12 (shown by block 44 of FIG. 2) and to then determine whether the specific mobile computing device 12 will support remote management by determining whether the mobile computing device 12 provides the necessary SMS libraries (block 46). Based on this information, a customised OTP security application is delivered to the user's mobile computing device 12, with this application only containing a module for the remote management of the OTP security application if the specific mobile computing device provides the correct SMS libraries. IF the mobile computing device 12 does not provide for the required SMS libraries, the customised OTP security application which is delivered will only include basic features but not a module for the remote management of the OTP security application (see block 48)

Therefore, by using the feedback information which is sent back from the mobile computing device 12 to the relevant turnkey server after the installation of the OTP security application, an administrator 28 of this network 18 or authentication entity is able to determine which users have authentication tokens which support remote management.

The mobile computing device 12 typically listens on a specific port of the mobile computing device 12 for SMS messages containing a command message and may execute the command messages received from the authentication token as they are received.

In an effort to control the use of mobile computing device ports and to avoid conflicts in communication, the Internet Assigned Numbers Authority (IANA) has assigned certain ports of mobile computing devices to certain applications. However, as many developers of mobile computing device software applications do not take these pre-assigned ports into consideration when developing communication strategies, the system of the present invention has to make use of particular methods to address this problem.

In the light of this, the turnkey server 22 of the authentication entity or network 18 chooses and registers a push SMS port during the installation of the OTP security application which includes a remote management module on the mobile computing device 12 (block 50). With the feedback information transmitted back from the mobile computing device 12 (shown by block 52 in FIG. 2), information is provided to confirm the port registration and to notify the turnkey server 22 if a port conflict occurs (block 54). The turnkey server 22 may then select another port, re-trying the installation process and repeating this process until a free port is found. Once deployment of the remote manager capability to the mobile computing device is successful (block 56), the turnkey server may display the additional remote management options for a particular user (block 58).

In order to remotely and dynamically manage the OTP security software application on the mobile computing device 12, the turnkey server of a particular network and authentication entity, e.g., turnkey server 22 generates a command message that is to be transmitted to the mobile computing device 12, via push-SMS technology, in one example embodiment.

The command message typically comprises command data specifying a type of command to be performed on the OTP security software application on the mobile computing device 12 as well as a unique identification code to either identify a data record or an OTP algorithm and the authentication entity associated with the command.

Through the use and implementation of these transmitted command messages, the turnkey server 22 can control the operation of the mobile computing device 12 acting as an authentication token. The various available command messages further allow for the modification of records in the authentication token's data store. Although command messages are primarily intended for remote management of the authentication token, it will be appreciated that certain components of the token itself could also issue commands in order to manage or control aspects of the token.

Examples of command messages are:
Add/Update authentication entity record—this command updates authentication data for a specified authentication entity, or adds an authentication entity if the entity does not exist on the OTP security application managing the mobile computing device as an authentication token.
Remove authentication entity record—this command removes the identified authentication entity from the OTP security application managing the mobile computing device as an authentication token.
Synchronise authentication entity—this command performs a synchronisation operation for the specified authentication entity.
Add/Update data record—this command updates or adds a general data record. Data records can be used for storing settings, user data or any other form of information that needs to be securely stored (including data required by plug-in modules).
Remove data record—this command deletes a general data record.

It follows from the available command messages, that it is possible to update the OTP algorithm used by a specific authentication entity, to add new authentication entities, to synchronise existing authentication entities and to add or remove arbitrary data on the mobile token. The command message set is therefore flexible enough to perform various tasks during the remote management of the OTP security application without any modification needed to the system implementing the remote management.

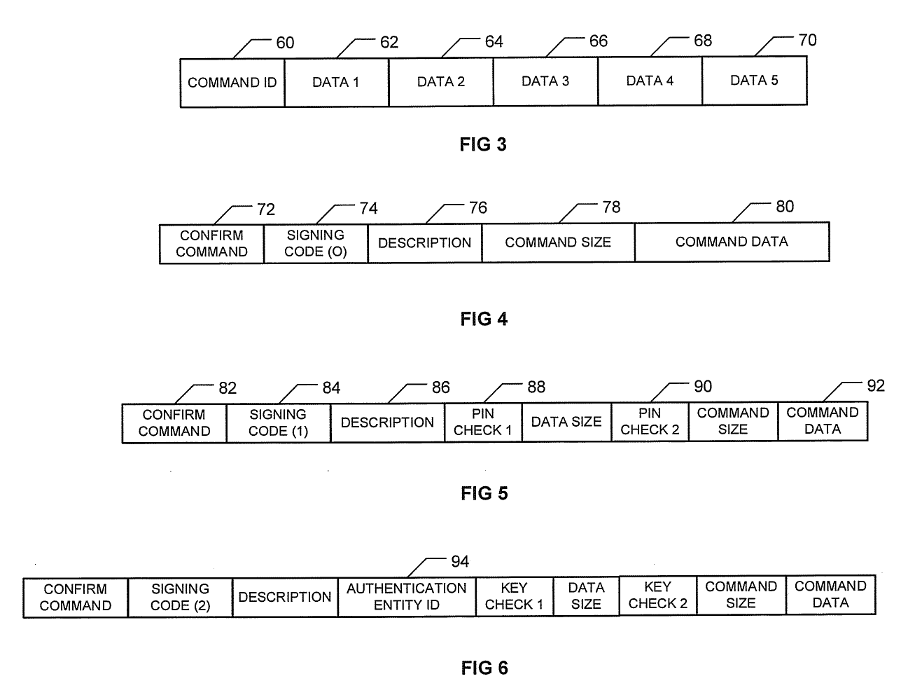

The structure of one example embodiment of the command message generated by a turnkey server is shown in FIG. 3. As shown by this Figure, the command message typically contains at least fields for a command identification (ID) number 60 and a first data field 62. The other four data fields 64 to 70 are optional and their use is dependent on the specific command type.

The authentication token uses the Command ID field 60 to determine which data fields are contained in the command message and what their respective data types are.

The command ID is the command data that specifies the type of command to be performed on the one time password security application on the mobile computing device. An example of a key to different Command ID's is shown in the table below:

| ID | Type of Command |
|---|---|
| 1 | Add/Update authentication entity |
| 2 | Remove authentication entity |
| 3 | Synchronise with authentication entity |
| 4 | Add/Update data record |
| 5 | Remove data record |

The actual data that may be contained in each command message (and the respective data fields of the command message), in accordance with an example embodiment is shown below:
1. Add/Update authentication entity—Adds a new authentication entity to the OTP token's storage system
   String Name—a descriptive name of the authentication entity to be added
   long ID—The unique authentication entity identification (ID) of the entity to add (also called companyID) (i.e., unique identification code)
   int dataSize—The size of the entity's raw data
   byte[ ] data—The entity's raw data, also called the entity's data-set. This is used by the relevant OTP algorithm and generally comprises a seed and iteration counter
2. Remove authentication entity—Removes an authentication entity from the OTP token's storage system
   long ID—The unique authentication entity ID or companyID of the entity/company to remove (i.e., unique identification code)
3. Synchronise company—Synchronises a specific authentication entity
   long companyID—The unique authentication entity ID of the entity to synchronise (i.e., unique identification code)
   String challenge—A challenge to pass to the OTP algorithm when synchronising the entity, the challenge forming part of a security check
4. Add/Update data—Adds a general data record to the OTP token's data store
   String Name—A description of the data to add
   long ID—The unique identification (ID) (i.e., unique identification code) of the data. This ID is used by the module to which the data belongs in order to access the data.
   int dataSize—The size of the data
   byte[ ] data—The actual data, which could represent anything.
5. Remove data—Removes a general data record from the OTP token's data store
   long ID—The unique ID of the general data record to remove (i.e., unique identification code)

In order to ensure that sufficient security is maintained during the remote management of the OTP security application on the mobile computing device, the command messages may be encrypted by the turnkey server 22 prior to their transmission to the mobile computing device 12.

In an example embodiment, the system and method provides for three basic command security levels, namely unencrypted, PIN encrypted and key encrypted. For each of these command security levels, the command message described above is embedded within a wrapper structure adapted for the particular command security level.

For unencrypted command messages no security features are implemented and these messages are readable by third-party observers. Although these command messages cannot be trusted, the unencrypted command messages remain useful when modifying non-critical data on the OTP security application. Advantageously, unencrypted command messages have a lower processing overhead than encrypted command messages, as no encryption/decryption needs to be performed to create or execute them.

Turning now to the example wrapper structure of an unencrypted command message shown in FIG. 4, the Confirm Command field 72 contains a byte sequence identifying the whole structure as a command. This identification is useful in a scenario where multiple modules use the same communication channel and it has to be determined whether the wrapper structure comprises command data or other data. The Signing Code field 74 is a single octet with the value “00000000”, indicating that an unencrypted security scheme is used on the command wrapper.

In the event that a mobile computing device 12 receives a command message, the user 10 of the mobile computing device 12 may be prompted and/or informed about the execution of the management command. The Description field 76 may in these circumstances be used to provide the user with information on the nature of the command message.

The Command data field 78 contains the actual command to be executed, as shown in FIG. 3.

PIN-encrypted commands use a predefined personal identification number (PIN) to encrypt the command message. This PIN can be any arbitrary byte sequence and may typically be used by an authentication entity that has no previous trust relationship with the OTP security application or mobile token deployed on the user's mobile computing device 12. For example, the administrator 36 or turnkey server 30 of the network 20 (i.e., authentication entity) may, for example, communicate the PIN to the user 10 over a second, secure communication channel. When the command wrapper is received, the user will be prompted for the PIN. This PIN is then used to decrypt the command message.

The structure of this type of command wrapper is shown in FIG. 5 and provides a self-contained mechanism for verifying the PIN entered by the user. The Confirm Command field 82, Signing Code field 84 and the Description field 86 are similar to those described in relation to FIG. 4. The PIN Check1 field 88 is an arbitrarily chosen byte sequence. The PIN Check2 field 90 is the result of encrypting the value of PIN Check1 with the PIN. When the user 10 enters a PIN to decrypt the command wrapper, the value of the PIN Check2 field 90 is first decrypted with the PIN, and the authentication token then determines whether this decrypted value corresponds to the value of the PIN Check1 field 88. If these two match it is established that the user must have entered the correct PIN and the command message can be decrypted.

The Command data field 92 contains the actual command to be executed, as shown in FIG. 3.

Key encrypted command messages present a secure method of command message transmission and execution that requires no user interaction. The basic command structure of the command wrapper, as shown in FIG. 6, is nearly identical to the PIN-encrypted command structure of FIG. 5. The command message is encrypted with a byte sequence, and checks are provided to verify the decryption process.

This command wrapper differs in the choice of byte sequence used for encryption and the inclusion of a field 94 for the authentication entity ID. Instead of using an arbitrary byte sequence as encryption key (e.g., the PIN-encrypted command messages described above), key-signed command messages make use of an existing shared symmetric key on the OTP security software already installed on the mobile computing device 12 during the installation process of the OTP security application. The authentication entity ID field 94 indicates which shared key the command message is signed with, since the authentication token may contain multiple such keys for the various authentication entities.

The key encrypted command structure makes it possible for authentication entities which have an existing trust relationship with a mobile computing device 12 and the installed authentication token to issue new command messages securely without requiring the user to enter a PIN.

In circumstances where asymmetric keys are used, the key-signed command messages from a given authentication entity are signed with that entity's public key in order to ensure that the command is legitimate and originates from that entity. PIN-encrypted commands described above may, in an example embodiment, be used to first deliver an authentication entity's public key securely, prior to the use of the asymmetric keys.

A difference between symmetric and asymmetric encryption is that, with asymmetric encryption, all encrypted command messages will be encrypted with the mobile authentication token's public key as well. As mentioned, this security key may be issued when the OTP security application is initially installed and deployed on the mobile computing device.

Although processing requirements of mobile computing devices are at this stage prohibitive in the implementation of the asymmetric encryption scheme, it is a logical continuation of the shared key encryption scheme.

It will be appreciated that the command security schemes mentioned above enable authentication entities to establish trust relationships with the mobile computing device 12.

As mentioned, a simplistic method of establishing a trust relationship between an authentication entity 18 or 20 and a mobile computing device 12 is to send a shared key to the OTP security application of the mobile computing device 12 with an Add company command message and encrypting this message with a PIN. This process requires no existing trust relationship of any kind between the authentication entity and the mobile computing device, as it only requires the secure transmission of the PIN to the user.

This method of establishing a trust relationship is equivalent to the method of installing a software application as described in PCT/IB2008/051580 as separate communication channels are used. For example, the PIN-encrypted command is included implicitly in the application source, and the user still needs to enter the PIN to establish the trust relationship.

Another authentication entity could follow the same procedure to establish a trust relationship with the user's mobile token. The authentication entity could create a new command message, encrypt the message with a PIN, and then transfer the command to the user's authentication token and the PIN to the user making use of a separate communication channel.

However, whenever this method is used it is necessary that the authentication entity first verifies that the entity/user to whom the PIN is to be transferred is indeed the legitimate user, and then to transfer the PIN to the user securely.

It will be appreciated that the nature of this secure transfer is dependent on the command security scheme used. If symmetric encryption is to be used, the PIN needs to remain secret and be transferred without modification. If asymmetric encryption is used, then the authentication entity needs to transfer its public key onto the user's authentication token, and transfer the authentication token's public key onto the authentication entity's turnkey servers without modification.

In both instances (symmetric and asymmetric) a certain amount of effort is required every time a new authentication entity (e.g., network 20) wants to establish a trust relationship with the mobile computing device 12. However, this may be addressed through making use of already established trust relationships between the authentication token and other authentication entities (e.g., network 18).

Key-signed/encrypted command messages are designed, in part, to circumvent this problem. Once an authentication entity such as network 18 has established a trust relationship with an authentication token 12, secondary authentication entities (i.e., authentication entities which do not have a trust relationship with the mobile computing device on which the OTP security application is installed, such as network 20) may issue key-signed command messages which are signed with the primary authentication entity's key (i.e., an entity with a trust relationship).

In the case of symmetric encryption the secondary authentication entities 20 will submit their inner command message to the primary authentication entity 18. The primary authentication entity 18 will then encrypt the command message with the security key it shares with the authentication token. It will be appreciated that this operation requires the secondary authentication entity 20 to trust the primary authentication entity 18, as the primary entity 18 will have access to the secondary entity's raw command message. Similarly, the primary authentication entity 18 needs to trust the secondary authentication entity 20, as the secondary authentication entity would be able to issue malicious command messages through the primary entity 18 to the authentication token.

For asymmetric encryption the primary authentication entity 18 may, in one example embodiment, only be used to deliver the secondary entity's public key to the mobile computing device acting as authentication token as well as to retrieve the authentication token's public key. The trust requirement between authentication entities is therefore greatly diminished, although both entities still need to trust each other.

Once a trust relationship has been established between an untrusted secondary entity and the token, the entity can then, in turn, function as a primary entity for future cases of establishing trust between the authentication token and other untrusted entities.

It follows from the above that the turnkey server securely transfers a shared security key to the authentication token. This security key can then be used to encrypt any future command messages sent from the turnkey server to the user's mobile computing device.

Once the OTP security application has been installed and activated on a user's mobile computing device 12 there is automatically a trust relationship between the authentication token and the turnkey server that issued the installation request. The turnkey server can in these circumstances create key-encrypted commands that will be verified correctly and decrypted by the mobile token.

Owing to the plug-in-based design of the OTP security application, the mobile token can potentially have a number of modules or components executing simultaneously. It will not always be obvious how these different components interact. In order to ensure that one component does not issue a command that can affect another component adversely, a command queuing system is implemented on the authentication token of the mobile computing device.

Any component on the mobile token can choose to execute a command directly, or to inject it into the command queue. If a component is unsure about the safety of immediately executing a specific command, that command should be placed in the command queue.

In most cases commands will originate from a SMS reception component or module which listens for incoming SMS's that carry command messages. As mentioned earlier, any other component could also be the source of command messages and hence could inject commands into the command queue. For example, commands may be delivered over MMS and Bluetooth, both of which will have their own modules that handle the incoming data.

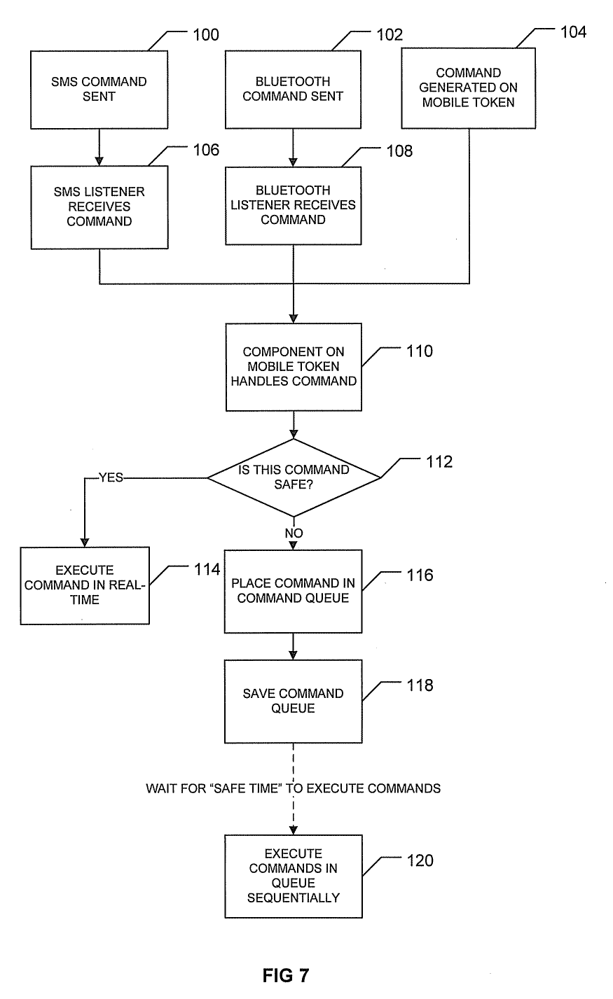

FIG. 7 shows the possible process flow for command messages received from various sources and placed in a queuing system. Command messages may originate from a variety of sources (indicated by blocks 100, 102 and 104) and these command messages are then passed to respective modules for processing and execution. The processing is indicated by blocks 106 where an SMS listener of the mobile computing device 12 receives the command and by block 108 where a Bluetooth listener receives the command. A component or module on the mobile computing device then handles the relevant command (block 110), but first it is determined whether the command message could safely be executed at the current time (shown by block 112).

If a command message can be executed immediately, it is sent to the command execution component for real-time execution as shown by block 114. Alternatively, the command message is injected into the command queue for later execution (block 116). This queuing mechanism stores the queue on non-volatile mobile computing device memory (block 118), so that the commands are not lost when the application is exited or the user's mobile computing device is switched off.

It will be appreciated that the next “safe time” (as shown by FIG. 7) only occurs the next time the token application is launched. In these circumstances, the queuing mechanism generally executes the command messages in the queue sequentially (block 120) directly after the mobile token's core services (such as its storage & encryption components) have been initialised, but prior to the various other components (e.g., plug-in modules) that could be affected adversely by the real-time command execution have been started.

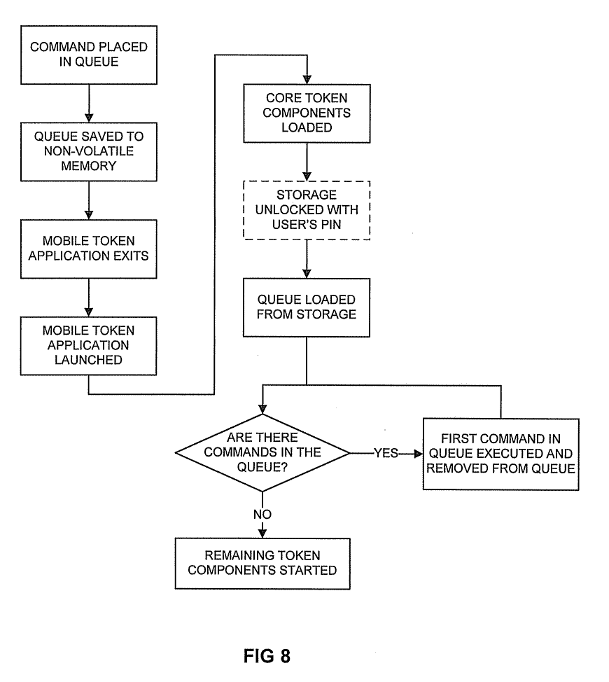

When the authentication token is starting up, the queuing system needs to retrieve the stored command messages, and thus requires access to the storage system. However, the storage system will generally be encrypted with a user-chosen PIN. The queuing system therefore may need to wait for the user to enter this PIN and thus unlock the storage system, before the command queue can be loaded from storage. FIG. 8 shows the operation of commands and the command queue during a token shutdown and restart cycle.

The most common remote management command messages transmitted to mobile computing devices may be token synchronisation commands. Token synchronisation commands are typically initiated automatically by a turnkey server of an authentication entity, by the users of the mobile computing devices themselves, or by an administrator of the authentication entity. Token synchronisation commands are described in detail below, in order to provide a specific example of the management of the OTP security application on a mobile computing device 12.

A user's mobile authentication token can drift out of synchronisation in a variety of circumstances. For example, if a user generates a number of OTPs with the token and then not use any of these OTPs for authenticating to the turnkey server of an authentication entity, the authentication token may fall out of synchronisation.

Detecting an out-of-sync token may be complicated as it may be difficult to distinguish between an out-of-sync OTP and an OTP that is simply incorrect. If a user has unsuccessfully entered an OTP a number of times then it is very likely that the token is no longer synchronised with the turnkey server.

The problem in managing the OTP security application is in deciding whether the user entering a potentially out-of-sync OTP is a legitimate user whose token is out-of-sync, or if it is a hacker attempting to hack into the user's account. It is therefore necessary to verify the identity of the user as a legitimate user prior to synchronising the token. This process of determining whether a user is a legitimate user or a hacker should preferably be done without making use of the standard (automatic-mode) OTP mechanism.

According to an example embodiment, two modes of OTP authentication are supported, namely an automatic mode, which generates a sequence of OTPs (based on a shared secret that is modified each time) and a challenge mode, which supplies an OTP in response to a challenge. It will be appreciated that challenge mode can never become out-of-sync. Each challenge is bound to a specific session and thus each OTP as well.

In the event that it is suspected that a user's token has become out-of-sync the following two alternatives may be performed:
1. Perform a remote synchronisation operation on the user's token without verifying that the token is indeed out of sync.
2. Use challenge mode to verify the identity of user, and then perform a synchronisation operation only if the user's identity is correctly verified. This significantly reduces the possibility of performing an unnecessary synchronisation attempt, and makes it impossible for a hacker to force a synchronisation.

If the method and system of the present invention is used to perform synchronisations there is no security risk associated with unnecessary synchronisations. The only issue to consider is the overhead and cost of the command delivery. Specific companies will implement their own policies concerning the criteria for synchronisations.

The synchronisation command message is generated by the turnkey server according to the data structures described in detail above. The command message is then transmitted to the authentication token of the mobile computing device over the chosen communication channel (e.g., SMS). Upon reception of the command message, the authentication token verifies the legitimacy of the command message according to command security schemes described above (e.g., decrypting the command message with the necessary security keys) and proceeds to execute the message (by means of a command queuing mechanism described in more detail below) thereby synchronising the authentication token with the turnkey server.

During synchronisation an OTP algorithm is passed a challenge code, which was sent as part of the command data, and returns some result value. It is assumed that the OTP algorithm uses the challenge to update some kind of internal iteration counter (which is part of the so-called company data on the token). It is further assumed that the result value can also be generated on the server that initially issued the synchronisation request. Thus successful synchronisation of the token can be verified by matching the server's result value with that of the token.

The present invention provides for a system and method whereby the algorithms used and the authentication entities supported by a mobile OTP token can be modified dynamically and without requiring software changes to the token. Similarly the system and method can be used to perform routine maintenance tasks, like token synchronisations, without user interaction. An authentication token implemented by OTP security applications downloaded onto a mobile computing device in accordance with the invention therefore address the limitations associated with traditional tokens.

This system and method further provide the benefit that the time users and administrators spend on maintenance operations on OTP security applications is reduced.

1. A method of managing a one time password security software application employed on a mobile computing device, the method comprising:
generating a command message comprising
command data specifying a type of command to be performed on the one time password security application employed on the mobile computing device, and
a unique identification code to identify a data record on which the command is to be performed or to identify a one time password algorithm and its associated authentication entity on which the command is to be performed; and
transmitting the command message to the mobile computing device for execution on the mobile computing device thereby to manage the one time password security software application.

2. The method of claim 1 wherein the mobile computing device is a mobile telephone, a Personal Digital Assistant (PDA) or another mobile computing device with wireless connectivity.

3. The method of claim 1 wherein the type of command specified by the command message is a command to update or add data associated with the authentication entity, a command to remove the authentication entity, a command to perform a synchronisation operation for the authentication entity, or commands to either add, update or delete general data records associated with the one time password security application.

4. The method of claim 1 wherein the method further comprises encrypting the command message prior to transmission.

5. The method of claim 4 wherein the encryption is symmetric or asymmetric encryption.

6. The method of claim 1 wherein the command message is transmitted from a turnkey server associated with the authentication entity identified through the unique identification code.

7. The method of claim 6 wherein a trust relationship exists between the mobile computing device and the authentication entity prior to the transmittal of the command message.

8. The method of claim 7 wherein the trust relationship between the mobile computing device and the authentication entity has been established during the installation of the one time password security application on the mobile computing device.

9. The method of claim 1 wherein the method further comprises, if a trust relationship does not exist between the authentication entity associated with the command message and the mobile computing device, transmitting the command message from a turnkey server associated with a trusted authentication entity that is not associated with the command message.

10. The method of claim 9 wherein the method comprises first transmitting the command message from a turnkey server not in a trust relationship with the mobile computing device, to a turnkey server in a trust relationship with the mobile computing device.

11. The method of claim 10 wherein the command message includes a security key associated with the turnkey server not in a trust relationship with the mobile computing device.

12. The method of claim 4 wherein the step of encrypting the command message includes transmitting a security key to the user of the mobile computing device over a second communication channel.

13. The method of claim 12 wherein the security key is a PIN.

14. The method of claim 4 wherein the step of encrypting the command message further includes encrypting the command message with an existing shared security key which was transmitted to the mobile commuting device during the installation process of the one time password security software application.

15. The method of claim 1 wherein the method further comprises receiving, at the mobile computing device, the command message and executing the command message thereby to manage the one time password security software application.

16. The method of claim 15 wherein the step of executing the command message comprises decrypting the command message.

17. A system to manage a one time password security software application employed on a mobile computing device, the system comprising:
a secure server of an authentication entity associated with a network, the network to be accessed by the mobile computing device through the use of a one time password;
the system being operable to:
generate a command message comprising
command data specifying a type of command to be performed on the one time password security application employed on the mobile computing device; and
a unique identification code to identify a data record on which the command is to be performed or to identify a one time password algorithm and its associated authentication entity on which the command is to be performed; and
transmit the command message to the mobile computing device for execution on the mobile computing device thereby to manage the one time password security software application.

18. The system of claim 17 wherein the secure server is configured to establish, during a registration process, a trust relationship with the authentication entity.

19. The system of claim 18 wherein the secure server is further configured to generate the command message by first receiving from a second server of a second authentication entity associated with a second network the command message.
